(19) United States
(12) Patent Application Publication
(10) Pub. No.: US 2025/0337546 A1
(43) Pub. Date: Oct. 30, 2025

(54) UPLINK REFERENCE SIGNAL RESOURCE CONFIGURATION

(71) Applicant: Nokia Technologies Oy, Espoo (FI)

(72) Inventors: Juha Pekka KARJALAINEN, Oulu (FI); Hiromasa UMEDA, Tokyo (JP); Sami-Jukka HAKOLA, Oulu (FI); Timo KOSKELA, Oulu (FI); Mihai ENESCU, Espoo (FI)

(21) Appl. No.: 18/855,441

(22) PCT Filed: Apr. 12, 2022
(86) PCT No.: PCT/EP2022/059693

§ 371 Date: Oct. 9, 2024

(51) Int. Cl. H04L 5/00; H04B 7/06

(52) U.S. Cl. CPC H04L 5/0051; H04B 7/0602

(57) ABSTRACT

Disclosed is a method comprising receiving, by a user device, from a network element of a radio access network, an uplink reference signal resource configuration comprising a plurality of uplink reference signal resources, wherein the uplink reference signal resource configuration is based on at least one of: a maximum number of transmit antenna ports supported for simultaneous transmissions from the user device to the network, and/or an antenna switching capability; and transmitting, by the user device, to the network element, the plurality of uplink reference signal resources based on the uplink reference signal resource configuration.

### FIELD

The following example embodiments relate to wireless communication.

### BACKGROUND

As resources are limited, it is desirable to optimize the usage of network resources.

### BRIEF DESCRIPTION

The scope of protection sought for various example embodiments is set out by the independent claims. The example embodiments and features, if any, described in this specification that do not fall under the scope of the independent claims are to be interpreted as examples useful for understanding various embodiments.

According to an aspect, there is provided an apparatus comprising at least one processor, and at least one memory including computer program code, wherein the at least one memory and the computer program code are configured, with the at least one processor, to cause the apparatus to: receive, from a network element of a radio access network, an uplink reference signal resource configuration comprising a plurality of uplink reference signal resources, wherein the uplink reference signal resource configuration is based on at least one of: a maximum number of transmit antenna ports supported for simultaneous transmissions from the apparatus to the network, and/or an antenna switching capability; and transmit, to the network element, the plurality of uplink reference signal resources based on the uplink reference signal resource configuration.

According to another aspect, there is provided an apparatus comprising means for: receiving, from a network element of a radio access network, an uplink reference signal resource configuration comprising a plurality of uplink reference signal resources, wherein the uplink reference signal resource configuration is based on at least one of: a maximum number of transmit antenna ports supported for simultaneous transmissions from the apparatus to the network, and/or an antenna switching capability; and transmitting, to the network element, the plurality of uplink reference signal resources based on the uplink reference signal resource configuration.

According to another aspect, there is provided a method comprising: receiving, by a user device, from a network element of a radio access network, an uplink reference signal resource configuration comprising a plurality of uplink reference signal resources, wherein the uplink reference signal resource configuration is based on at least one of: a maximum number of transmit antenna ports supported for simultaneous transmissions from the user device to the network, and/or an antenna switching capability; and transmitting, by the user device, to the network element, the plurality of uplink reference signal resources based on the uplink reference signal resource configuration.

According to another aspect, there is provided a computer program comprising instructions which, when executed by an apparatus, cause the apparatus to perform at least the following: receiving, from a network element of a radio access network, an uplink reference signal resource configuration comprising a plurality of uplink reference signal resources, wherein the uplink reference signal resource configuration is based on at least one of: a maximum number of transmit antenna ports supported for simultaneous transmissions from the apparatus to the network, and/or an antenna switching capability; and transmitting, to the network element, the plurality of uplink reference signal resources based on the uplink reference signal resource configuration.

According to another aspect, there is provided a computer program comprising instructions for causing an apparatus to perform at least the following: receiving, from a network element of a radio access network, an uplink reference signal resource configuration comprising a plurality of uplink reference signal resources, wherein the uplink reference signal resource configuration is based on at least one of: a maximum number of transmit antenna ports supported for simultaneous transmissions from the apparatus to the network, and/or an antenna switching capability; and transmitting, to the network element, the plurality of uplink reference signal resources based on the uplink reference signal resource configuration.

According to another aspect, there is provided a computer readable medium comprising program instructions for causing an apparatus to perform at least the following: receiving, from a network element of a radio access network, an uplink reference signal resource configuration comprising a plurality of uplink reference signal resources, wherein the uplink reference signal resource configuration is based on at least one of: a maximum number of transmit antenna ports supported for simultaneous transmissions from the apparatus to the network, and/or an antenna switching capability; and transmitting, to the network element, the plurality of uplink reference signal resources based on the uplink reference signal resource configuration.

According to another aspect, there is provided a non-transitory computer readable medium comprising program instructions for causing an apparatus to perform at least the following: receiving, from a network element of a radio access network, an uplink reference signal resource configuration comprising a plurality of uplink reference signal resources, wherein the uplink reference signal resource configuration is based on at least one of: a maximum number of transmit antenna ports supported for simultaneous transmissions from the apparatus to the network, and/or an antenna switching capability; and transmitting, to the network element, the plurality of uplink reference signal resources based on the uplink reference signal resource configuration.

According to another aspect, there is provided an apparatus comprising at least one processor, and at least one memory including computer program code, wherein the at least one memory and the computer program code are configured, with the at least one processor, to cause the apparatus to: determine an uplink reference signal resource configuration based on at least one of: a maximum number of transmit antenna ports supported by a user device for simultaneous transmissions from the user device to the apparatus, and/or an antenna switching capability of the user device; transmit, to the user device, the uplink reference signal resource configuration comprising a plurality of uplink reference signal resources; and receive, from the user device, the plurality of uplink reference signal resources based on the uplink reference signal resource configuration.

According to another aspect, there is provided an apparatus comprising means for: determining an uplink reference signal resource configuration based on at least one of: a maximum number of transmit antenna ports supported by a user device for simultaneous transmissions from the user device to the apparatus, and/or an antenna switching capability of the user device; transmitting, to the user device, the uplink reference signal resource configuration comprising a plurality of uplink reference signal resources; and receiving, from the user device, the plurality of uplink reference signal resources based on the uplink reference signal resource configuration.

According to another aspect, there is provided a method comprising: determining, by a network element of a radio access network, an uplink reference signal resource configuration based on at least one of: a maximum number of transmit antenna ports supported by a user device for simultaneous transmissions from the user device to the network element, and/or an antenna switching capability of the user device; transmitting, by the network element, to the user device, the uplink reference signal resource configuration comprising a plurality of uplink reference signal resources; and receiving, by the network element, from the user device, the plurality of uplink reference signal resources based on the uplink reference signal resource configuration.

According to another aspect, there is provided a computer program comprising instructions which, when run on an apparatus, cause the apparatus to perform at least the following: determining an uplink reference signal resource configuration based on at least one of: a maximum number of transmit antenna ports supported by a user device for simultaneous transmissions from the user device to the apparatus, and/or an antenna switching capability of the user device; transmitting, to the user device, the uplink reference signal resource configuration comprising a plurality of uplink reference signal resources; and receiving, from the user device, the plurality of uplink reference signal resources based on the uplink reference signal resource configuration.

According to another aspect, there is provided a computer program comprising instructions for causing an apparatus to perform at least the following: determining an uplink reference signal resource configuration based on at least one of: a maximum number of transmit antenna ports supported by a user device for simultaneous transmissions from the user device to the apparatus, and/or an antenna switching capability of the user device; transmitting, to the user device, the uplink reference signal resource configuration comprising a plurality of uplink reference signal resources; and receiving, from the user device, the plurality of uplink reference signal resources based on the uplink reference signal resource configuration.

According to another aspect, there is provided a computer readable medium comprising program instructions for causing an apparatus to perform at least the following: determining an uplink reference signal resource configuration based on at least one of: a maximum number of transmit antenna ports supported by a user device for simultaneous transmissions from the user device to the apparatus, and/or an antenna switching capability of the user device; transmitting, to the user device, the uplink reference signal resource configuration comprising a plurality of uplink reference signal resources; and receiving, from the user device, the plurality of uplink reference signal resources based on the uplink reference signal resource configuration.

According to another aspect, there is provided a non-transitory computer readable medium comprising program instructions for causing an apparatus to perform at least the following: determining an uplink reference signal resource configuration based on at least one of: a maximum number of transmit antenna ports supported by a user device for simultaneous transmissions from the user device to the apparatus, and/or an antenna switching capability of the user device; transmitting, to the user device, the uplink reference signal resource configuration comprising a plurality of uplink reference signal resources; and receiving, from the user device, the plurality of uplink reference signal resources based on the uplink reference signal resource configuration.

According to another aspect, there is provided a system comprising at least a user device and a network element of a radio access network. The network element is configured to: determine an uplink reference signal resource configuration based on at least one of: a maximum number of transmit antenna ports supported by the user device for simultaneous transmissions from the user device to the network element, and/or an antenna switching capability of the user device; transmit, to the user device, the uplink reference signal resource configuration comprising a plurality of uplink reference signal resources; and receive, from the user device, the plurality of uplink reference signal resources based on the uplink reference signal resource configuration. The user device is configured to: receive, from the network element, the uplink reference signal resource configuration comprising the plurality of uplink reference signal resources; and transmit, to the network element, the plurality of uplink reference signal resources based on the uplink reference signal resource configuration.

According to another aspect, there is provided a system comprising at least a user device and a network element of a radio access network. The network element comprises means for: determining an uplink reference signal resource configuration based on at least one of: a maximum number of transmit antenna ports supported by the user device for simultaneous transmissions from the user device to the network element, and/or an antenna switching capability of the user device; transmitting, to the user device, the uplink reference signal resource configuration comprising a plurality of uplink reference signal resources; and receiving, from the user device, the plurality of uplink reference signal resources based on the uplink reference signal resource configuration. The user device comprises means for: receiving, from the network element, the uplink reference signal resource configuration comprising the plurality of uplink reference signal resources; and transmitting, to the network element, the plurality of uplink reference signal resources based on the uplink reference signal resource configuration.

### LIST OF DRAWINGS

In the following, various example embodiments will be described in greater detail with reference to the accompanying drawings, in which

FIG. 1 illustrates an example embodiment of a cellular communication network;

FIG. 2 illustrates an example of uplink sounding reference signal antenna switching;

FIG. 3 illustrates an example of an uplink sounding reference signal resource configuration;

FIG. 4 illustrates an example of an uplink sounding reference signal antenna switching resource configuration;

FIG. 5 illustrates an example of an uplink sounding reference signal antenna switching resource configuration;

FIG. 6 illustrates an example of an uplink sounding reference signal antenna switching resource configuration;

FIG. 7 illustrates a signaling diagram according to an example embodiment;

FIG. 8 illustrates a flow chart according to an example embodiment;

FIG. 9 illustrates a flow chart according to an example embodiment;

FIGS. 10a and 10b illustrate examples of enhanced antenna switching;

FIG. 11 illustrates an example of combined usage of legacy and enhanced antenna switching;

FIG. 12 illustrates an example embodiment of an apparatus; and

FIG. 13 illustrates an example embodiment of an apparatus.

### DETAILED DESCRIPTION

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

In the following, different example embodiments will be described using, as an example of an access architecture to which the example embodiments may be applied, a radio access architecture based on long term evolution advanced (LTE Advanced, LTE-A), new radio (NR, 5G), beyond 5G, or sixth generation (6G) without restricting the example embodiments to such an architecture, however. It is obvious for a person skilled in the art that the example embodiments may also be applied to other kinds of communications networks having suitable means by adjusting parameters and procedures appropriately. Some examples of other options for suitable systems may be the universal mobile telecommunications system (UMTS) radio access network (UTRAN or E-UTRAN), long term evolution (LTE, substantially the same as E-UTRA), wireless local area network (WLAN or Wi-Fi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

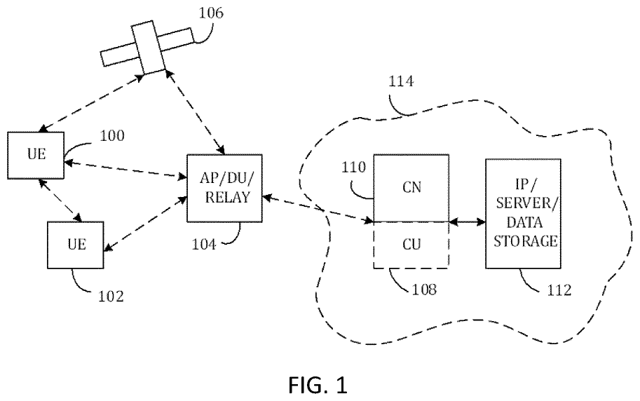

FIG. 1 depicts examples of simplified system architectures showing some elements and functional entities, all being logical units, whose implementation may differ from what is shown. The connections shown in FIG. 1 are logical connections; the actual physical connections may be different. It is apparent to a person skilled in the art that the system may also comprise other functions and structures than those shown in FIG. 1.

The example embodiments are not, however, restricted to the system given as an example but a person skilled in the art may apply the solution to other communication systems provided with necessary properties.

The example of FIG. 1 shows a part of an exemplifying radio access network.

FIG. 1 shows user devices 100 and 102 configured to be in a wireless connection on one or more communication channels in a radio cell with an access node 104, such as an evolved Node B (abbreviated as eNB or eNodeB) or a next generation Node B (abbreviated as gNB or gNodeB), providing the radio cell. The physical link from a user device to an access node may be called uplink or reverse link, and the physical link from the access node to the user device may be called downlink or forward link. A user device may also communicate directly with another user device via sidelink communication. It should be appreciated that access nodes or their functionalities may be implemented by using any node, host, server or access point etc. entity suitable for such a usage.

A communication system may comprise more than one access node, in which case the access nodes may also be configured to communicate with one another over links, wired or wireless, designed for the purpose. These links may be used for signaling purposes. The access node may be a computing device configured to control the radio resources of communication system it is coupled to. The access node may also be referred to as a base station, a base transceiver station (BTS), an access point or any other type of interfacing device including a relay station capable of operating in a wireless environment. The access node may include or be coupled to transceivers. From the transceivers of the access node, a connection may be provided to an antenna unit that establishes bi-directional radio links to user devices. The antenna unit may comprise a plurality of antennas or antenna elements. The access node may further be connected to a core network 110 (CN or next generation core NGC). Depending on the system, the counterpart on the CN side may be a serving gateway (S-GW, routing and forwarding user data packets), packet data network gateway (P-GW) for providing connectivity of user devices to external packet data networks, user plane function (UPF), mobility management entity (MME), access and mobility management function (AMF), or location management function (LMF), etc.

The user device illustrates one type of an apparatus to which resources on the air interface may be allocated and assigned, and thus any feature described herein with a user device may be implemented with a corresponding apparatus, such as a relay node. The user device may also be called a subscriber unit, mobile station, remote terminal, access terminal, user terminal, terminal device, or user equipment (UE) just to mention but a few names or apparatuses.

An example of such a relay node may be a layer 3 relay (self-backhauling relay) towards the access node. The self-backhauling relay node may also be called an integrated access and backhaul (IAB) node. The IAB node may comprise two logical parts: a mobile termination (MT) part, which takes care of the backhaul link(s) (i.e., link(s) between IAB node and a donor node, also known as a parent node) and a distributed unit (DU) part, which takes care of the access link(s), i.e., child link(s) between the IAB node and user device(s), and/or between the IAB node and other IAB nodes (multi-hop scenario).

Another example of such a relay node may be a layer 1 relay called a repeater. The repeater may amplify a signal received from an access node and forward it to a user device, and/or amplify a signal received from the user device and forward it to the access node.

The user device may refer to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example may be a camera or video camera loading images or video clips to a network. A user device may also be a device having capability to operate in Internet of Things (IoT) network which is a scenario in which objects may be provided with the ability to transfer data over a network without requiring human-to-human or human-to-computer interaction. The user device may also utilize cloud. In some applications, a user device may comprise a small portable or wearable device with radio parts (such as a watch, earphones or eyeglasses) and the computation may be carried out in the cloud. The user device (or in some example embodiments a layer 3 relay node) may be configured to perform one or more of user equipment functionalities. The user device may also comprise, or be comprised in, a robot or a vehicle such as a train or a car.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question may have inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input—multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications may support a wide range of use cases and related applications including video streaming, augmented reality, different ways of data sharing and various forms of machine type applications (such as (massive) machine-type communications (mMTC), including vehicular safety, different sensors and real-time control. 5G may have multiple radio interfaces, namely below 6 GHz, cmWave and mmWave, and also being integrable with existing legacy radio access technologies, such as the LTE. Integration with the LTE may be implemented, at least in the early phase, as a system, where macro coverage may be provided by the LTE, and 5G radio interface access may come from small cells by aggregation to the LTE. In other words, 5G may support both inter-RAT operability (such as LTE-5G) and inter-RI operability (inter-radio interface operability, such as below 6 GHz-cmWave-mmWave). One of the concepts considered to be used in 5G networks may be network slicing, in which multiple independent and dedicated virtual sub-networks (network instances) may be created within the substantially same infrastructure to run services that have different requirements on latency, reliability, throughput and mobility.

The current architecture in LTE networks may be fully distributed in the radio and fully centralized in the core network. The low latency applications and services in 5G may need to bring the content close to the radio which leads to local break out and multi-access edge computing (MEC). 5G may enable analytics and knowledge generation to occur at the source of the data. This approach may need leveraging resources that may not be continuously connected to a network such as laptops, smartphones, tablets and sensors. MEC may provide a distributed computing environment for application and service hosting. It may also have the ability to store and process content in close proximity to cellular subscribers for faster response time. Edge computing may cover a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system may also be able to communicate with other networks, such as a public switched telephone network or the Internet 112, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head (RRH) or a radio unit (RU), or an access node comprising radio parts. It may also be possible that node operations are distributed among a plurality of servers, nodes or hosts. Carrying out the RAN real-time functions at the RAN side (in a distributed unit, DU 104) and non-real time functions in a centralized manner (in a central unit, CU 108) may be enabled for example by application of cloudRAN architecture.

It should also be understood that the distribution of labour between core network operations and access node operations may differ from that of the LTE or even be non-existent. Some other technology advancements that may be used include big data and all-IP, which may change the way networks are being constructed and managed. 5G (or new radio, NR) networks may be designed to support multiple hierarchies, where MEC servers may be placed between the core and the access node. It should be appreciated that MEC may be applied in 4G networks as well.

5G may also utilize non-terrestrial communication, for example satellite communication, to enhance or complement the coverage of 5G service, for example by providing backhauling. Possible use cases may be providing service continuity for machine-to-machine (M2M) or Internet of Things (IoT) devices or for passengers on board of vehicles, or ensuring service availability for critical communications, and future railway/maritime/aeronautical communications. Satellite communication may utilize geostationary earth orbit (GEO) satellite systems, but also low earth orbit (LEO) satellite systems, in particular mega-constellations (systems in which hundreds of (nano)satellites are deployed). At least one satellite 106 in the mega-constellation may cover several satellite-enabled network entities that create on-ground cells. The on-ground cells may be created through an on-ground relay node 104 or by a gNB located on-ground or in a satellite.

6G networks are expected to adopt flexible decentralized and/or distributed computing systems and architecture and ubiquitous computing, with local spectrum licensing, spectrum sharing, infrastructure sharing, and intelligent automated management underpinned by mobile edge computing, artificial intelligence, short-packet communication and blockchain technologies. Key features of 6G may include intelligent connected management and control functions, programmability, integrated sensing and communication, reduction of energy footprint, trustworthy infrastructure, scalability and affordability. In addition to these, 6G is also targeting new use cases covering the integration of localization and sensing capabilities into system definition to unifying user experience across physical and digital worlds.

It is obvious for a person skilled in the art that the depicted system is only an example of a part of a radio access system and in practice, the system may comprise a plurality of access nodes, the user device may have an access to a plurality of radio cells and the system may also comprise other apparatuses, such as physical layer relay nodes or other network elements, etc. At least one of the access nodes may be a Home eNodeB or a Home gNodeB.

Furthermore, the access node may also be split into: a radio unit (RU) comprising a radio transceiver (TRX), i.e., a transmitter (Tx) and a receiver (Rx); one or more distributed units (DUs) that may be used for the so-called Layer 1 (L1) processing and real-time Layer 2 (L2) processing; and a central unit (CU) (also known as a centralized unit) that may be used for non-real-time L2 and Layer 3 (L3) processing. The CU may be connected to the one or more DUs for example by using an F1 interface. Such a split may enable the centralization of CUs relative to the cell sites and DUs, whereas DUs may be more distributed and may even remain at cell sites. The CU and DU together may also be referred to as baseband or a baseband unit (BBU). The CU and DU may also be comprised in a radio access point (RAP).

The CU may be defined as a logical node hosting higher layer protocols, such as radio resource control (RRC), service data adaptation protocol (SDAP) and/or packet data convergence protocol (PDCP), of the access node. The DU may be defined as a logical node hosting radio link control (RLC), medium access control (MAC) and/or physical (PHY) layers of the access node. The operation of the DU may be at least partly controlled by the CU. The CU may comprise a control plane (CU-CP), which may be defined as a logical node hosting the RRC and the control plane part of the PDCP protocol of the CU for the access node. The CU may further comprise a user plane (CU-UP), which may be defined as a logical node hosting the user plane part of the PDCP protocol and the SDAP protocol of the CU for the access node.

Cloud computing platforms may also be used to run the CU and/or DU. The CU may run in a cloud computing platform, which may be referred to as a virtualized CU (vCU). In addition to the vCU, there may also be a virtualized DU (vDU) running in a cloud computing platform. Furthermore, there may also be a combination, where the DU may use so-called bare metal solutions, for example application-specific integrated circuit (ASIC) or customer-specific standard product (CSSP) system-on-a-chip (SoC) solutions. It should also be understood that the distribution of labour between the above-mentioned access node units, or different core network operations and access node operations, may differ.

Additionally, in a geographical area of a radio communication system, a plurality of different kinds of radio cells as well as a plurality of radio cells may be provided. Radio cells may be macro cells (or umbrella cells) which may be large cells having a diameter of up to tens of kilometers, or smaller cells such as micro-, femto- or picocells. The access node(s) of FIG. 1 may provide any kind of these cells. A cellular radio system may be implemented as a multilayer network including several kinds of radio cells. In multilayer networks, one access node may provide one kind of a radio cell or radio cells, and thus a plurality of access nodes may be needed to provide such a network structure.

For fulfilling the need for improving the deployment and performance of communication systems, the concept of “plug-and-play” access nodes may be introduced. A network which may be able to use “plug-and-play” access nodes, may include, in addition to Home eNodeBs or Home gNodeBs, a Home Node B gateway, or HNB-GW (not shown in FIG. 1). An HNB-GW, which may be installed within an operator's network, may aggregate traffic from a large number of Home eNodeBs or Home gNodeBs back to a core network.

In wireless communication systems, information may be transmitted via a radio channel. The effect of the channel on the transmitted signal may need to be estimated in order to recover the transmitted data. For example, with binary phase shift keying (BPSK), binary information is represented as +1 and −1 symbol values. The radio channel may apply a phase shift to the transmitted symbols, possibly inverting the symbol values. As long as the receiver can estimate what the channel did to the transmitted signal, it can accurately recover the data comprised in the signal.

Reference signals (RS), which may also be referred to as pilots, may be transmitted along with the data for example to obtain channel state information knowledge for proper decoding of received signals. Reference signals are pre-defined signals that are known at both the transmitter and receiver. Thus, the receiver can estimate the effect of the channel by comparing the received reference signal with the original reference signal known at the receiver. Reference signals may be used in both downlink (DL) and uplink (UL) for example for obtaining accurate channel knowledge in order to derive channel state information (CSI), for demodulating data, for allowing the receiver to perform fine time and frequency channel tracking, for UL/DL beam management, for UL/DL scheduling purposes, and/or for interference estimation in UL/DL.

For example, the following reference signals may be used in NR: demodulation reference signal (DMRS), phase-tracking reference signal (PTRS), non-zero power (NZP) channel state information reference signal (CSI-RS), synchronization signal block (SSB), and sounding reference signal (SRS).

SRS is an uplink reference signal that may be transmitted by a UE for example to assist a base station to obtain the CSI for the UE. CSI describes how the transmitted signal from the UE to the base station is impacted by a channel, and it represents the combined effect of scattering, fading, power decay, time delay and Doppler spread and/or Doppler shift. Furthermore, the channel may also cover implementation-specific impacts at a transmitter and/or receiver, such as a frequency offset due to oscillator drifting at the transmitter and/or receiver. The system may use the SRS for resource scheduling, link adaptation, positioning, massive MIMO, and/or beam management. The SRS may be configured specific to a given UE or group specifically covering a group of UEs. In NR Release 15, in the time domain, SRS may span 1, 2 or 4 consecutive symbols, which may be mapped within the last six symbols of the slot. In NR Release 17, the time-span of UL SRS can be up to 14 symbols (covering also options e.g. up to 8, 10 and 12 symbols). Multiple SRS symbols allow coverage extension and increased sounding capacity.

NR Release 15 (Rel-15) can operate with a beam-based mode, both below and above the 6 GHz carrier frequency range, where both the transmitter and receiver may use spatial domain beamforming (e.g., in analog or digital domain) at Tx and/or Rx to cover a propagation loss associated with a radio channel. UEs may be equipped with multiple receive antenna panels associated with multiple antenna elements. Depending on the UE reception capability, a set of UE antenna panels may be simultaneously used for reception.

A parameter called simultaneousReceptionDiffTypeD-r16 may indicate whether the UE supports simultaneous reception with different quasi co-location (QCL) type D reference signals. In NR Release 17 (Rel-17), both DL and UL transmission schemes for reference signals, other signals, and channels may be enhanced to enable more flexible and efficient support for multiple transmission and reception point (multi-TRP) operation.

NR Rel-15 provides support for single-user DL PDSCH scheduling for up to 8 layers (i.e., rank 8). However, Rel-15 UL SRS resource configuration with antenna switching can provide support for UEs equipped with up to 4 receive antenna ports. In other words, even though a UE may be equipped for example with 8 receive antenna ports, in NR Rel-15 just 4 out of the 8 antenna ports can be used for DL CSI acquisition at gNB-based UL SRS sounding. This may lead to suboptimal use of DL Tx precoding as well as Rx processing, thus limiting system performance for example in terms of spectral efficiency and interference mitigation.

Although a UE may comprise, for example, 4 or 8 receive antennas, the number of its uplink transmit antennas may be smaller, since UL transmission may be more power-limited than DL transmission, and it may be more efficient to not increase the number of layers per UE in power-limited conditions. Furthermore, adding Tx radio frequency (RF) chains to the UE may cause several implementation issues, such as excessive UE power drainage, and placement overlaps for example with cameras and sensors in smart phones. A single Tx RF chain may be connected to one of the receive antennas through a switch when it transmits SRS. This switch may be used to switch the Tx RF chain between the different receive antennas in order to alternate the transmission of SRS from different antennas. This switching may be referred to as antenna switching. A UE may transmit an individual SRS for a given receive antenna, and the base station (e.g., gNB) may then construct a channel matrix from the received SRS responses. The base station can decide the best precoder and/or beamforming weights to maximize DL capacity without quantization error, as long as the received quality of SRS is high enough.

In NR Rel-15, depending on the UE's reported antenna switching capability, the UE can be configured with one of the following antenna switching configurations, where T defines the number of transmit antenna ports and R defines the number of receive antenna ports at the UE side. Herein the term “antenna port” may refer to a logical antenna port. The indicated UE antenna switching capability of ‘xTyR’ corresponds to a UE capable of SRS transmission on ‘x’ antenna ports over a total of ‘y’ antennas, where ‘y’ corresponds to all or a subset of the UE receive antennas.
‘t1r2’ for 1T2R (i.e., one transmit antenna port selected from two receive antenna ports),
‘t1r1-t1r2’ for 1T=1R/1T2R (i.e., one transmit antenna port and one or two receive antenna ports),
‘t2r4’ for 2T4R (i.e., two transmit antenna ports and four receive antenna ports),
‘t1r4’ for 1T4R (i.e., one transmit antenna port and four receive antenna ports),
‘t1r1-t1r2-t1r4’ for 1T=1R/1T2R/1T4R (i.e., one transmit antenna port and one, two or four receive antenna ports),
‘t1r4-t2r4’ for 1T4R/2T4R (i.e., one or two transmit antenna ports and four receive antenna ports),
‘t1r1-t1r2-t2r2-t2r4’ for 1T=1R/1T2R/2T=2R/2T4R (i.e., one transmit antenna port and one receive antenna port, or one transmit antenna port and two receive antenna ports, or two transmit antenna ports and two receive antenna ports, or two transmit antenna ports and four receive antenna ports),
‘t1r1-t1r2-t2r2-t1r4-t2r4’ for 1T=1R/1T2R/2T=2R/1T4R/2T4R (i.e., one transmit antenna port and one receive antenna port, or one transmit antenna port and two receive antenna ports, or two transmit antenna ports and two receive antenna ports, or one transmit antenna ports and four receive antenna ports, or two transmit antenna ports and four receive antenna ports),
‘t1r1’ for 1T=1R (i.e., one transmit antenna port and one receive antenna port),
‘t2r2’ for 2T=2R (i.e., two transmit antenna ports and two receive antenna ports), ‘t1r1-t2r2’ for 1T=1R/2T=2R (i.e., one transmit antenna port and one receive antenna port, or two transmit antenna ports and two receive antenna ports),
‘t4r4’ for 4T=4R (i.e., four transmit antenna ports and four receive antenna ports), or
‘t1r1-t2r2-t4r4’ for 1T=1R/2T=2R/4T=4R (i.e., one transmit antenna port and one receive antenna port, or two transmit antenna ports and two receive antenna ports, or four transmit antenna ports and four receive antenna ports).

NR Rel-15 provides support for resource-specific repetition, where one UL SRS resource can be repeated in up to 4 symbols (including also repetition of 2 symbols). In NR Rel-15, the SRS resource can be configured into 1 or 2 or 4 of the last 6 symbols in a slot. Furthermore, NR Rel-15 supports UL SRS resource configuration with intra-slot frequency domain hopping with repetition, where a set of subcarriers is to be sounded in 2 or 4 consecutive OFDM symbols within a slot before the next frequency hop occurs.

NR Rel-15 supports the following SRS time domain behaviors: periodic, semi-persistent, and aperiodic transmissions. With semi-persistent SRS transmission, MAC control elements (CEs) are used to activate and deactivate a semi-persistent set of one or more SRS resources. While activated, a semi-persistent SRS resource is transmitted with a configured periodicity and slot offset. This MAC CE activation/deactivation mechanism enables more dynamic on/off control compared to periodic SRS resources, which are configured by RRC signaling.

In NR Rel-15, a given UE may be configured with a UL SRS antenna switching resource configuration as follows:

For 1T2R, up to two SRS resource sets may be configured with a different value for the higher layer parameter resourceType in the SRS-ResourceSet set, where a given set has two SRS resources transmitted in different symbols, the first SRS resource in the set consisting of a single SRS port, and the SRS port of the second resource in the set is associated with a different UE antenna port than the SRS port of the first resource in the set.

For 2T4R, up to two SRS resource sets may be configured with a different value for the higher layer parameter resourceType in the SRS-ResourceSet set, where a given SRS resource set has two SRS resources transmitted in different symbols, the first SRS resource in the set consisting of two SRS ports, and the SRS port pair of the second resource in the set is associated with a different UE antenna port pair than the SRS port pair of the first resource in the set.

For 1T4R, zero or one SRS resource set may be configured with the higher layer parameter resourceType in the SRSResourceSet set to ‘periodic’ or ‘semi-persistent’ with four SRS resources transmitted in different symbols, a given SRS resource in a given set consisting of a single SRS port, and the SRS ports of the resources are associated with different UE antenna ports.

For 1T4R, zero or two SRS resource sets may be configured with the higher layer parameter resourceType in the SRSResourceSet set to ‘aperiodic’ and with a total of four SRS resources transmitted in different symbols of two different slots, and where the SRS ports of the SRS resources in the two sets are associated with different UE antenna ports.

For 1T=1R, or 2T=2R, or 4T=4R, up to two SRS resource sets may be configured with one SRS resource per set, where the number of SRS ports for a given resource may be equal to 1, 2, or 4.

To enable enhanced system performance, NR Rel-17 further enhanced MIMO (FeMIMO) may provide support for UL SRS antenna switching configurations with 6 (=R) and 8 UE receive antenna ports, for example xT6R and xT8R.

In the following, some different alternatives for the maximum number of aperiodic UL SRS resource sets (N_max) in NR Rel-17 are presented: 1T6R: N_max=3, 1T8R: N_max=4, 2T6R: N_max=3, 2T8R: N_max=4, 4T8R: N_max=2.

From a network perspective, the above alternatives may be useful for enabling a larger number of different UL SRS antenna switching configurations compared with NR Rel-15 (up to N_max=2). By enabling support for a larger number of resource sets, UL SRS transmissions can be distributed more flexibly across different slots. Otherwise, UL SRS resource transmissions may restrict UL resource utilization for PUSCH and PUCCH transmissions.

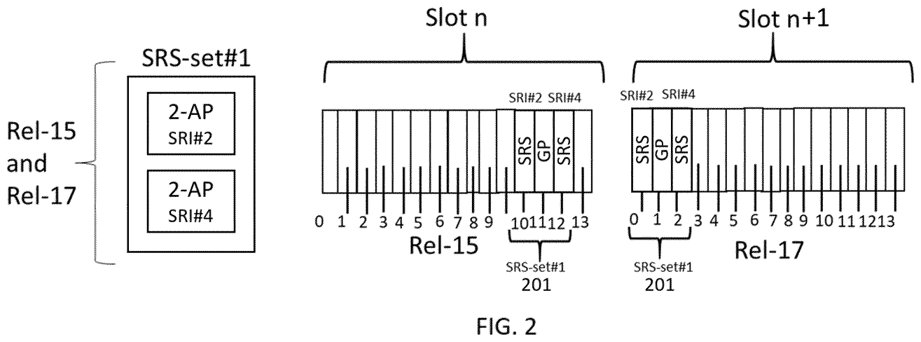

FIG. 2 illustrates an example of UL SRS antenna switching with NR Rel-15 and NR Rel-17 resource configurations for two transmit antenna ports and four receive antenna ports (2T4R). Herein one UL SRS resource set 201 (SRS-set #1) is configured with two resources, i.e., sounding reference signal indicator (SRI) #2 and #4, with two antenna ports (2-AP). It is assumed that a guard period is located between resources within the UL SRS resource set. Furthermore, it is assumed that the UE can transmit simultaneously via both antenna ports associated with the resource. In NR Rel-15, UL SRS resources can be configured into up to four out of the last six symbols in a slot. In comparison, NR Rel-17 may enable to configure UL SRS resources into any symbol position in the slot.

Table 1 below shows the minimum guard periods (GP) between two SRS resources of an SRS resource set according to NR Rel-15. The guard period is a time period between two SRS resources. During the guard period, the UE is not allowed to receive or transmit any reference signals, data or control information. The guard period may also be referred to as a guard interval. Guard periods may be used to ensure that distinct transmissions do not interfere with one another, or otherwise cause overlapping transmissions. In Table 1, Y denotes the minimum length of the guard period in OFDM symbols, Δf denotes subcarrier spacing in kHz, and p is an integer number (=0,1,2,3) that is used to define the scaling factor for the subcarrier spacing. The scaling factor enables to define the intended subcarrier spacing value with respect to 15 kHz basis numerology.

TABLE 1

| μ | Δf = 2^{μ} · 15 [kHz] | Y [symbol] |
|---|---|---|
| 0 | 15 | 1 |
| 1 | 30 | 1 |
| 2 | 60 | 1 |
| 3 | 120 | 2 |

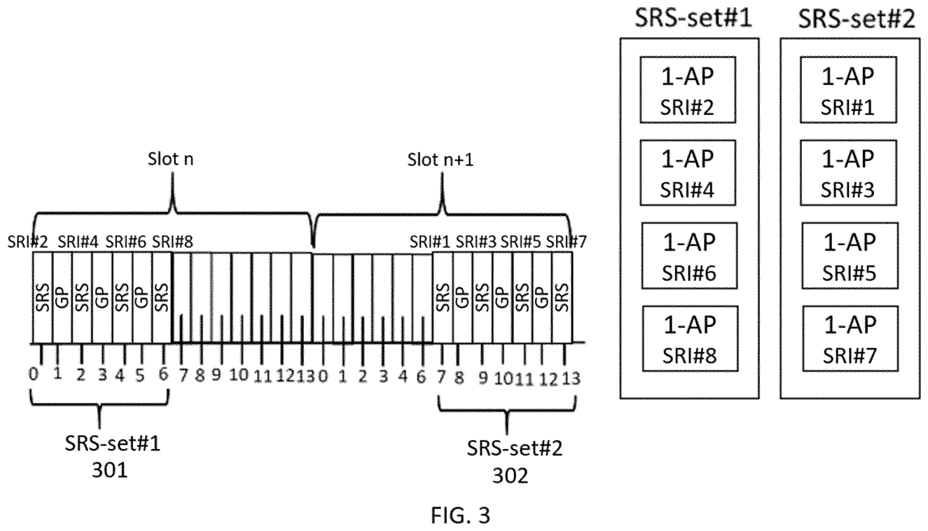

FIG. 3 illustrates an example of UL SRS resource configuration for 1T8R with 15 kHz subcarrier spacing (SCS). In FIG. 3, two different aperiodic SRS resource sets 301, 302 (SRS-set #1 and SRS-set #2) associated with different slot offset values (i.e., n and n+1) are configured for 1T8R, wherein a given resource set has four different one-antenna-port (1-AP) resources associated with different symbols.

In NR Rel-18, there is a target to identify and specify enhancements for uplink MIMO. Furthermore, enhancements for downlink MIMO, which facilitate the use of large antenna array for both frequency range one (FR1) and frequency range two (FR2), may be needed for evolution of NR deployments. NR Rel-18 may specify enhanced mechanisms for UL SRS to enable more flexible triggering on aperiodic SRS sets.

NR Rel-17provides support for UL SRS antenna switching for up to eight receive antenna ports and four transmit antenna ports. However, NR Rel-17 lacks support for a higher number of transmit antenna ports than four, which NR Rel-18 aims to address. Some example embodiments may provide an UL SRS antenna switching configuration and UE procedure enhancements with more than four transmit antenna ports for example in the context of multi-TRP operation.

A higher peak data rate for UL may be beneficial in short-range applications, such as home entertainment, video surveillance/monitoring in industrial/healthcare/safety, IAB, and other applications where the device power and/or form-factor may not be as stringent as with current handheld devices. UL transmission with more than four transmit antenna ports may be useful in bridging the gap between DL and UL spectral efficiency, in both FR1 and FR2. Hence, there may be a need to provide methods and/or signalling solutions to overcome this issue for NR Rel-18 or beyond.

For operation with more than four transmit antenna ports, both SRS-based UL CSI and DL CSI acquisitions may need to be enhanced. The following issue related to UL SRS antenna switching with simultaneous transmission may be identified, when a UE operates with more than four UL SRS ports at FR1 and/or FR2 (or even higher) for example in multi-TRP scenarios.

The issue is related to the lack of specification support for antenna switching configurations for more than four transmit UL SRS ports. Additionally, to enable enhanced DL operation in NR Rel-18 and beyond, it may be desirable to extend UL antenna switching configurations also with eight or more receive antenna ports. For example, in NR Rel-18 and beyond, UEs may have different levels of reception and transmission capabilities with respect to current handheld devices, such as customer-premises equipment (CPE), fixed wireless access (FWA), vehicles, and/or industrial devices.

For example, one or more of the following UL SRS antenna switching configurations with asymmetricity between transmit and receive antenna ports may be envisionedfor NRRel-18 andbeyond: 6T8R, 7T8R, 8T10R, 9T10R,10T11R,10T12R, and/or 11T12R.

However, none of the UL SRS antenna switching configurations in the above list are supported by the NR Rel-17 specifications. Therefore, it may be beneficial to develop resource configurations and transmission procedures for them.

In the following, some example embodiments are described by using UL SRS as an example of an uplink reference signal. However, it should be noted that some example embodiments may also be applied to any other uplink reference signal, where antenna port switching capability and simultaneous transmission capability is involved. Some examples of such other uplink reference signals may include, for example, demodulation reference signal (DMRS) and phase-tracking reference signal (PTRS).

Some example embodiments relate to NR physical layer design for MIMO enhancements in NR Rel-18 and beyond. More specifically, some example embodiments may enable UL SRS operation with more than four transmit antenna ports. To this end, some example embodiments may provide an UL SRS antenna switching resource configuration and a UE transmission procedure for simultaneous uplink transmission with more than four transmit antenna ports with reduced usage of guard period(s).

Some example embodiments may reduce latency and resource overhead in time, as well as scheduling restrictions for a UE. Furthermore, some example embodiments may enable UL SRS resource configuration and transmission procedure support for new antenna switching configurations, such as 5T8R (i.e., five transmit antenna ports and eight receive antenna ports), 6T8R (i.e., six transmit antenna ports and eight receive antenna ports), 7T8R (i.e., seven transmit antenna ports and eight receive antenna ports), 8T10R (i.e., eight transmit antenna ports and ten receive antenna ports), 9T10R (i.e., nine transmit antenna ports and ten receive antenna ports), 10T11R (i.e., ten transmit antenna ports and eleven receive antenna ports), 10T12R (i.e., ten transmit antenna ports and twelve receive antenna ports), and/or 11T12R (i.e., eleven transmit antenna ports and twelve receive antenna ports).

In an example embodiment, an xTyR UL SRS resource configuration is provided for antenna switching with a UE having simultaneous UL x>4 transmit antenna port capability and/or simultaneous y>8 DL receive antenna port capability.

In one approach, the UE may be configured with one or more UL SRS resource sets for antenna switching with a different number of transmit antenna ports (AP) between UL SRS resources within a given UL SRS resource set.

For example, for a 6T8R UL SRS antenna switching resource configuration, two UL SRS resources, SRI #i and SRI #j (where i≠j), may be configured with Nᵢ=6 and Nⱼ=2 transmit antenna ports, respectively. The UE may assume that at least one guard period is located between the resources.

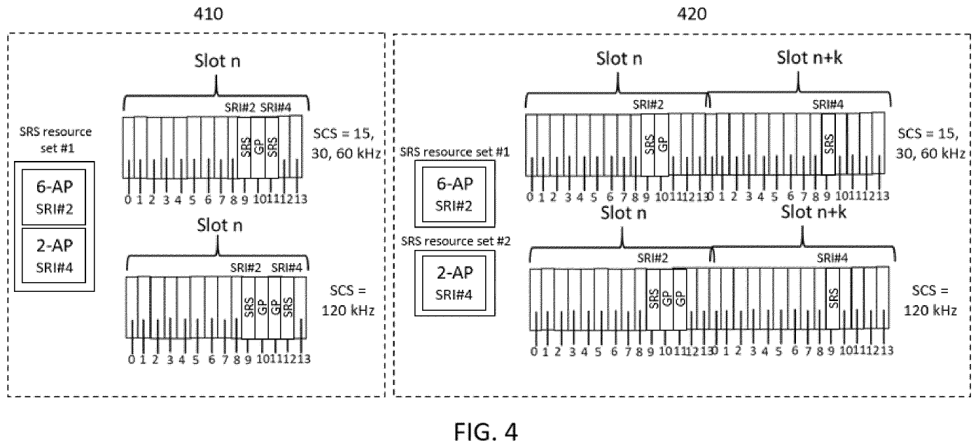

FIG. 4 illustrates an example of an UL SRS antenna switching configuration for 6T8R with one or two aperiodic resource sets with different numerology options.

In the example of FIG. 4, the UL SRS antenna switching configuration has two aperiodic resources (SRI #2 and SRI #4) transmitted in different symbols of one or two slots, depending on the number of resource sets (e.g., one or two) configured by a network. With an SCS of 15, 30 or 60 kHz, the configuration with aperiodic resources consumes three OFDM symbols, including a guard period, within one or two slots. With an SCS of 120 kHz, the configuration with aperiodic resources consumes four OFDM symbols, including two guard periods, within one or two slots. In the case of periodic or semi-persistent resources, the UE may be configured with one resource set assigned into a single slot. Alternatively, with periodic or semi-persistent resources, different resources may be configured to different slots resource-specifically. Herein the term “slot” refers to a time slot.

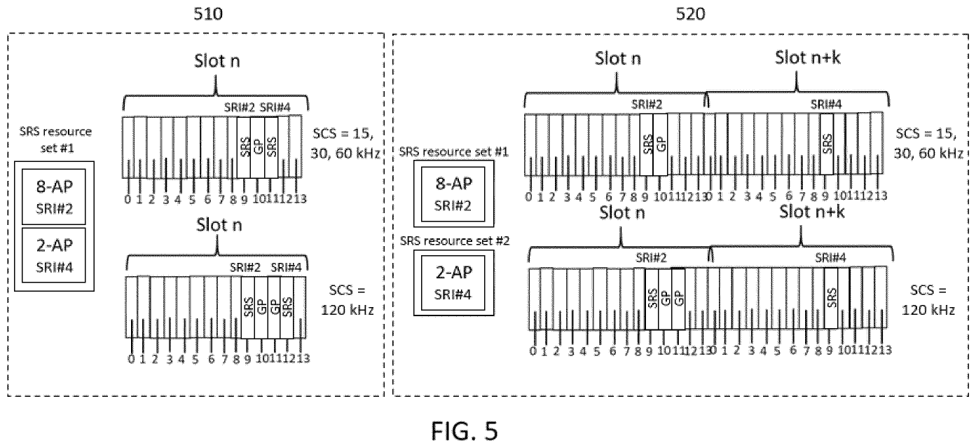

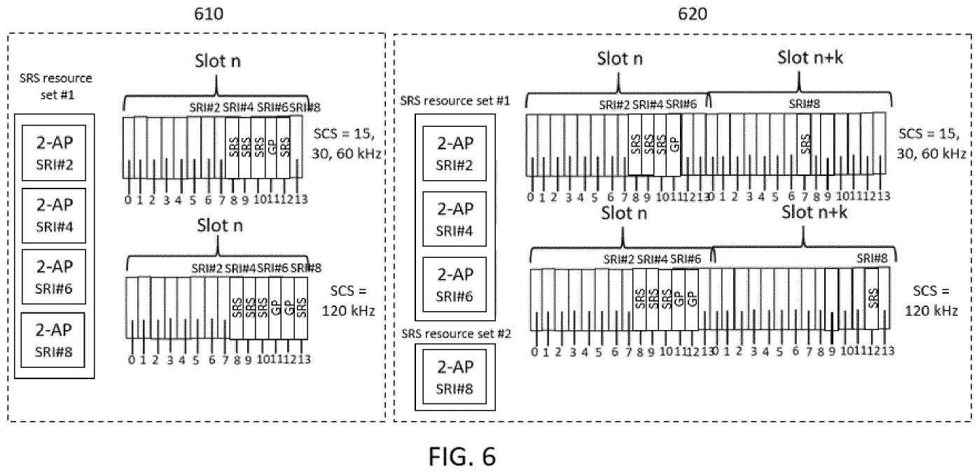

It should be noted that the time-domain location of the guard period between resources and/or different resource sets may be based on UE capability signaling. As a result of this, it may not be necessary to configure the time-domain location of the guard period in the way as shown in this example or the following examples of FIGS. 5-6.

In FIG. 4, block 410 illustrates a configuration with one aperiodic resource set. In block 410, one UL SRS resource set (SRS resource set #1) is configured for 6T8R with two resources denoted as SRI #2 and SRI #4, wherein SRI #2 is associated with six antenna ports (6-AP), and SRI #4 is associated with two antenna ports (2-AP).

Referring to block 410, with an SCS of 15, 30 or 60 kHz, the UE may transmit SRI #2 in OFDM symbol #9 of slot n via the six antenna ports associated with SRI #2, and the UE may transmit SRI #4 in OFDM symbol #11 of slot n via the two antenna ports associated with SRI #4. In this case, there may be a guard period in OFDM symbol #10 of slot n between SRI #2 and SRI #4.

Alternatively, with an SCS of 120 kHz, there may be two guard periods in OFDM symbols #10 and #11 of slot n between SRI #2 and SRI #4, and thus SRI #4 may be transmitted later in OFDM symbol #12.

In FIG. 4, block 420 illustrates a configuration with two aperiodic resource sets. In block 420, two different UL SRS resource sets (SRS resource set #1 and SRS resource set #2) associated with different slot offset values (i.e., n and n+k, for example k=1) are configured for 6T8R. SRS resource set #1 comprises a single resource denoted as SRI #2, wherein this resource is associated with six antenna ports (6-AP). SRS resource set #2 comprises a single resource denoted as SRI #4, wherein this resource is associated with two antenna ports (2-AP). It should be noted that the example is not limited to two consecutive slots (i.e., slot n and slot n+1, k=1), but is applicable also for any resource configuration with non-consecutive slots (e.g., slot n and slot n+5, k=5).

Referring to block 420, with an SCS of 15, 30 or 60 kHz, the UE may transmit SRI #2 in OFDM symbol #9 of slot n via the six antenna ports associated with SRI #2. Furthermore, the UE may transmit SRI #4 in OFDM symbol #9 of slot n+k via the two antenna ports associated with SRI #4. In this case, there may be a guard period for example in OFDM symbol #10 of slot n between SRI #2 and SRI #4.

Alternatively, with an SCS of 120 kHz, there may be two guard periods in for example OFDM symbols #10 and #11 of slot n between SRI #2 and SRI #4.

FIG. 5 illustrates an example of an UL SRS antenna switching configuration for 8T10R with one or two aperiodic resource sets with different numerology options.

In FIG. 5, block 510 illustrates a configuration with one aperiodic resource set. In block 510, one UL SRS resource set (SRS resource set #1) is configured for 8T10R with two resources denoted as SRI #2 and SRI #4, wherein SRI #2 is associated with eight antenna ports (8-AP), and SRI #4 is associated with two antenna ports (2-AP).

Referring to block 510, with an SCS of 15, 30 or 60 kHz, the UE may transmit SRI #2 in OFDM symbol #9 of slot n via the eight antenna ports associated with SRI #2, and the UE may transmit SRI #4 in OFDM symbol #11 of slot n via the two antenna ports associated with SRI #4. In this case, there may be a guard period in OFDM symbol #10 of slot n between SRI #2 and SRI #4.

Alternatively, with an SCS of 120 kHz, there may be two guard periods in OFDM symbols #10 and #11 of slot n between SRI #2 and SRI #4, and thus SRI #4 may be transmitted later in OFDM symbol #12.

In FIG. 5, block 520 illustrates a configuration with two aperiodic resource sets. In block 520, two different UL SRS resource sets (SRS resource set #1 and SRS resource set #2) associated with different slot offset values (i.e., n and n+k, for example k=1) are configured for 8T10R. SRS resource set #1 comprises a single resource denoted as SRI #2, wherein this resource is associated with eight antenna ports (8-AP). SRS resource set #2 comprises a single resource denoted as SRI #4, wherein this resource is associated with two antenna ports (2-AP). It should be noted that the example is not limited to two consecutive slots (i.e., slot n and slot n+1, k=1), but is applicable also for any resource configuration with non-consecutive slots (e.g., slot n and slot n+5, k=5).

Referring to block 520, with an SCS of 15, 30 or 60 kHz, the UE may transmit SRI #2 in OFDM symbol #9 of slot n via the eight antenna ports associated with SRI #2. Furthermore, the UE may transmit SRI #4 in OFDM symbol #9 of slot n+k via the two antenna ports associated with SRI #4. In this case, there may be a guard period for example in OFDM symbol #10 of slot n between SRI #2 and SRI #4.

Alternatively, with an SCS of 120 kHz, there may be two guard periods for example in OFDM symbols #10 and #11 of slot n between SRI #2 and SRI #4.

In an alternative approach, the total number of transmit antenna ports supported by the UE may be distributed into different resources. The UE may be configured with K₁ different UL SRS resources with M₁ transmit antenna ports in a given UL resource set, where K₁=R/M₁ (M₁<X) is an integer number, and the M₁ simultaneous transmit antenna ports is a subset of X. Herein X denotes the simultaneous UL TX antenna port capability of the UE, i.e., the maximum number of transmit antenna ports supported by the UE for simultaneous transmission. In other words, X refers to the x in xTyR. R refers to the number of receive antenna ports supported by the UE. When UL SRS resources are configured within one resource set, the UE may assume that the first X/M₁ resources out of K₁ resources do not have a guard period between resources. For the rest of the resources, K₁-X/M₁, depending on UE capability signaling, the UE may assume that one or more guard periods exist between resources within the resource set.

For example, for a 6T8R antenna switching resource configuration, four (K₁=4) UL SRS resources, SRI #1, SRI #2, SRI #3 and SRI #4, may be configured with M₁=2 antenna ports. For SRI #1, #2 and #3, there may be no guard period between resources. Between SRI #3 and #4, there may be a guard period between resources. It is assumed that the UE can transmit UL SRS resources without a guard period between the resources, when the total number of antenna ports associated with the aforementioned resources is less than or equal to X.

FIG. 6 illustrates an example of an UL SRS antenna switching configuration for 6T8R with a reduced number of guard periods with one or two aperiodic resource sets with different numerology options.

In the example of FIG. 6, four aperiodic resources are transmitted in different symbols of one or two slots depending on the number of resource sets (e.g., one or two) configured by a network. Here it is assumed that, due to UE capability for simultaneous use of six transmit antenna ports and capability signaling related to need for a guard period, no guard period between the first three symbols is needed, and just one OFDM symbol for a guard period is reserved between the third and fourth resources, thus reducing guard period overhead. With an SCS of 15, 30 or 60 kHz, in both options 610 and 620, aperiodic resources consume five OFDM symbols, including a guard period, within one or two slots. With an SCS of 120 kHz, in both options 610 and 620, aperiodic resources consume six OFDM symbols, including two guard periods, within one or two slots.

In FIG. 6, block 610 illustrates a configuration with one aperiodic resource set. In block 610, one UL SRS resource set (SRS resource set #1) is configured for 6T8R with four resources denoted as SRI #2, SRI #4, SRI #6 and SRI #8, wherein a given resource is associated with two antenna ports (2-AP).

Referring to block 610, with an SCS of 15, 30 or 60 kHz, the UE may transmit SRI #2 in OFDM symbol #8 of slot n via the two antenna ports associated with SRI #2. The UE may transmit SRI #4 in OFDM symbol #9 of slot n via the two antenna ports associated with SRI #4. The UE may transmit SRI #6 in OFDM symbol #10 of slot n via the two antenna ports associated with SRI #6. The UE may transmit SRI #8 in OFDM symbol #12 of slot n via the two antenna ports associated with SRI #8. In this case, depending on the UE capability signaling, there may be a guard period in OFDM symbol #11 of slot n between SRI #6 and SRI #8. However, since the UE is capable of simultaneous transmission with six transmit antenna ports (i.e., with three different pairs of transmit antenna ports), the first three resources SRI #2, SRI #4 and SRI #6 may be transmitted by using these three different transmit antenna port pairs, and thus there is no need to have a guard period between SRI #2 and SRI #4, or between SRI #4 and SRI #6.

For example, the four 2-AP resources (SRI #2, SRI #4, SRI #6, SRI #8) may be transmitted as follows: SRI #2 is transmitted with antenna ports #0 and #1, SRI #4 is transmitted with antenna ports #2 and #3, SRI #6 is transmitted with antenna ports #4 and #5, SRI #8 is transmitted with antenna ports #6 and #7. In this case, antenna ports #0 to #5 may refer to the six transmit antenna ports that the UE is capable of using for simultaneous transmission, and antenna ports #6 and #7 may be receive antenna ports. In other words, the UE may perform antenna switching to use the receive antenna ports #6 and #7 as transmit antenna ports.

Alternatively, with an SCS of 120 kHz, there may be two guard periods in OFDM symbols #10 and #11 of slot n between SRI #6 and SRI #8, and thus SRI #8 may be transmitted later in OFDM symbol #13 of slot n.

In FIG. 6, block 620 illustrates a configuration with two aperiodic resource sets. In block 620, two different UL SRS resource sets (SRS resource set #1 and SRS resource set #2) associated with different slot offset values (i.e., n and n+k, for example k=1) are configured for 6T8R. SRS resource set #1 comprises three resources denoted as SRI #2, SRI #4, and SRI #6, wherein a given resource in this set is associated with two antenna ports (2-AP). SRS resource set #2 comprises a single resource denoted as SRI #8, wherein this resource is associated with two antenna ports (2-AP). It should be noted that the example is not limited to two consecutive slots (i.e., slot n and slot n+1, k=1), but is applicable also for any resource configuration with non-consecutive slots (e.g., slot n and slot n+5, k=5).

Referring to block 620, with an SCS of 15, 30 or 60 kHz, the UE may transmit SRI #2 in OFDM symbol #8 of slot n via the two antenna ports associated with SRI #2. The UE may transmit SRI #4 in OFDM symbol #9 of slot n via the two antenna ports associated with SRI #4. The UE may transmit SRI #6 in OFDM symbol #10 of slot n via the two antenna ports associated with SRI #6. The UE may transmit SRI #8 in OFDM symbol #7 of slot n+k (e.g., k=1) via the two antenna ports associated with SRI #8. In this case, there may be a guard period for example in OFDM symbol #11 of slot n between SRI #6 and SRI #8. However, since the UE is capable of simultaneous transmission with six transmit antenna ports (i.e., with three different pairs of transmit antenna ports), the first three resources SRI #2, SRI #4 and SRI #6 may be transmitted by using different transmit antenna port pairs, and thus there is no need to have a guard period between SRI #2 and SRI #4, or between SRI #4 and SRI #6.

Alternatively, with an SCS of 120 kHz, there may be two guard periods for example in OFDM symbols #11 and #12 of slot n between SRI #6 and SRI #8, and SRI #8 may be transmitted in a different symbol, for example OFDM symbol #12 of slot n+k.

Some example embodiments are described below using principles and terminology of 5G technology without limiting the example embodiments to 5G communication systems, however.

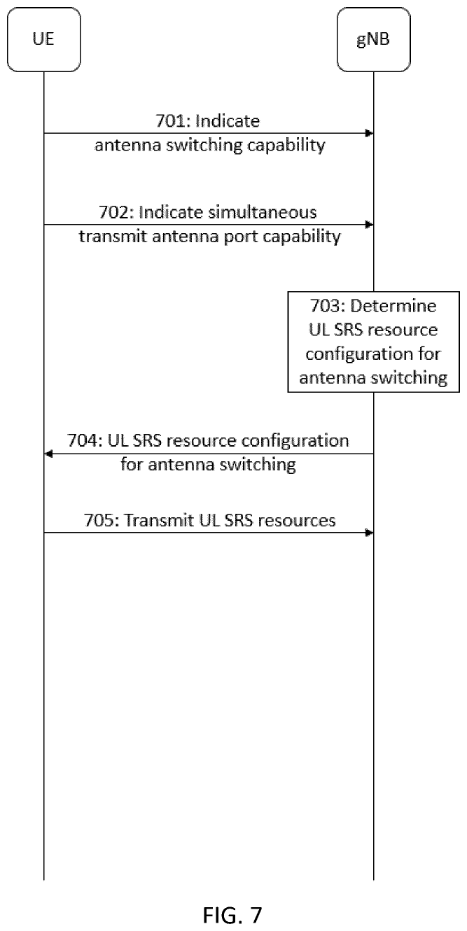

FIG. 7 illustrates a signaling diagram according to an example embodiment.

Referring to FIG. 7, in step 701, a UE indicates, via capability signaling, to a network element (e.g., a gNB) of a radio access network, the antenna switching capability of the UE. The antenna switching capability may indicate the transmit antenna port switching pattern supported by the UE. The indicated UE antenna switching capability of ‘xTyR’ corresponds to the UE being capable of SRS transmission on ‘x’ antenna ports out of a total of ‘y’ antenna ports, where ‘y’ corresponds to all or a subset of the receive antenna ports of the UE. For example, the antenna switching capability may indicate a capability to transmit SRS on two or more antenna ports of a plurality (two or more) of receive antenna ports of the UE. As another example, the antenna switching capability may indicate a capability to transmit SRS on five or more antenna ports of eight or more receive antenna ports of the UE.

The antenna switching capability may also be referred to as ‘enhanced-SRS-Tx-port-switching’ capability herein. The ‘enhanced-SRS-Tx-port-switching’ capability means that the UE has enhanced antenna switching capability compared to an NR Rel-15 UE, for example. In other words, the ‘enhanced-SRS-Tx-port-switching’ capability enables to reduce the number of guard periods between UL SRS resources within or between different time slots. This kind of UE may be NR Rel-17 or Rel-18, or beyond those releases.

In step 702, the UE indicates, via capability signaling, to the network element, the maximum supported antenna switching configuration (e.g., 5T8R, 6T8R, 7T8R, 8T10R, 9T10R, 10T11R, 10T12R, or 11T12R) indicating the maximum number of transmit antenna ports supported by the UE for simultaneous transmissions. For example, the maximum number of transmit antenna ports supported for the simultaneous transmissions may be five or more. The maximum number of transmit antenna ports supported by the UE for the simultaneous transmissions may also be referred to as an ‘enhanced-SRS-simultaneous-Tx-ports’ capability herein.

The ‘enhanced-SRS-simultaneous-Tx-ports’ capability may be indicated together with the ‘enhanced-SRS-Tx-port-switching’ capability, or these two capabilities may be indicated separately. In other words, the UE may transmit, to the network element, one or more indications indicating at least one of: the maximum number of transmit antenna ports supported for the simultaneous transmissions, and/or the antenna switching capability. The UE may indicate the capabilities for example during RRC connection establishment or re-establishment to the network element.

The indicated maximum supported antenna switching configuration may implicitly indicate that the subsequent antenna switching combinations under the indicated one are also supported. For example, if the UE indicates that it supports 8T10R (eight transmit antenna ports and ten receive antenna ports), then it may implicitly indicate, for example, that 2T4R (two transmit antenna ports and four receive antenna ports) is also supported.

In step 703, the network element determines an UL SRS resource configuration for antenna switching for the UE based on at least one of: the antenna switching capability of the UE and/or the maximum number of transmit antenna ports supported by the UE for the simultaneous transmissions. For example, the network element may determine to configure the UE with the maximum supported antenna switching configuration. Alternatively, depending on data traffic and/or radio channel conditions, the network element may determine to configure the UE with some other supported antenna switching configuration than the maximum one.

In step 704, the network element transmits the determined UL SRS resource configuration to the UE for example via RRC and/or MAC-level signaling. The UL SRS resource configuration comprises a plurality of UL SRS resources.

In step 705, the UE transmits the plurality of UL SRS resources based on the UL SRS resource configuration received from the network element. The UE may transmit the plurality of UL SRS resources with a reduced number of guard periods compared to an NR Rel-15 UE.

For example, if the UE indicated 6T8R capability (i.e., capability to transmit on six transmit antenna ports simultaneously) and/or enhanced antenna switching capability, and the UL SRS resource configuration comprises four 2-AP resources, then the UE may assume that there is no guard period between the first three 2-AP resources, and that there is a guard period between the third and fourth 2-AP resources.

For example, the UL SRS resource configuration may comprise one of: 5T8R, 6T8R, 7T8R, 8T10R, 9T10R, 10T11R, 10T12R, or 11T12R. The UL SRS resource configuration may correspond, for example, to any of the configuration examples of FIGS. 4-6. However, the UL SRS resource configuration is not restricted to the examples of FIGS. 4-6, and it may also be different than the examples of FIGS. 4-6. Alternatively, the UL SRS resource configuration may comprise a legacy configuration, such as 2T2R or 2T4R, wherein the number of guard periods may be reduced compared to NR Rel-15.

For example, the plurality of UL SRS resources may comprise at least a first resource and a second resource, wherein at least one of the first and second resources is associated with a different number of antenna ports, and a number of antenna ports associated with the first resource or the second resource is equal to the maximum number of transmit antenna ports supported for the simultaneous transmissions (e.g., see the 6T8R configuration of FIG. 4, where SRI #2 is a 6-AP resource and SRI #4 is a 2-AP resource). In this example, the first resource and the second resource may be transmitted with at least one guard period between the first resource and the second resource.

As another example, the plurality of UL SRS resources may comprise at least two resources that are transmitted in consecutive symbols without a guard period between the at least two resources, wherein a sum of antenna ports associated with the at least two resources is less than or equal to the maximum number of transmit antenna ports supported for the simultaneous transmissions. In this example, a further resource of the plurality of UL SRS resources may be transmitted with at least one guard period between the further resource and the at least two resources, wherein a sum of antenna ports associated with the further resource and the at least two resources exceeds the maximum number of transmit antenna ports supported for the simultaneous transmissions (e.g., see the 6T8R configuration of FIG. 6, where SRI #2, #4 and #6 are transmitted without a guard period between them, but there is a guard period between SRI #6 and #8). In this example, the number of resources comprised in the plurality of UL SRS resources may be equal to a number of receive antenna ports divided by a number of antenna ports associated per resource of the plurality of UL SRS resources (e.g., there may be four 2-AP resources in a 6T8R configuration, since 8/2=4).

FIG. 8 illustrates a flow chart according to an example embodiment of a method performed by an apparatus such as, or comprising, or comprised in, a user device. The user device may also be called a subscriber unit, mobile station, remote terminal, access terminal, user terminal, terminal device, or user equipment (UE). The user device may correspond to one of the user devices 100, 102 of FIG. 1.

Referring to FIG. 8, in block 801, an uplink reference signal resource configuration comprising a plurality of uplink reference signal resources is received from a network element of a radio access network, wherein the uplink reference signal resource configuration is based on at least one of: a maximum number of transmit antenna ports supported for simultaneous transmissions from the apparatus to the network, and/or an antenna switching capability of the apparatus. For example, the uplink reference signal may comprise one of: a sounding reference signal, a demodulation reference signal, or a phase-tracking reference signal.

In block 802, the plurality of uplink reference signal resources are transmitted to the network element based on the uplink reference signal resource configuration.

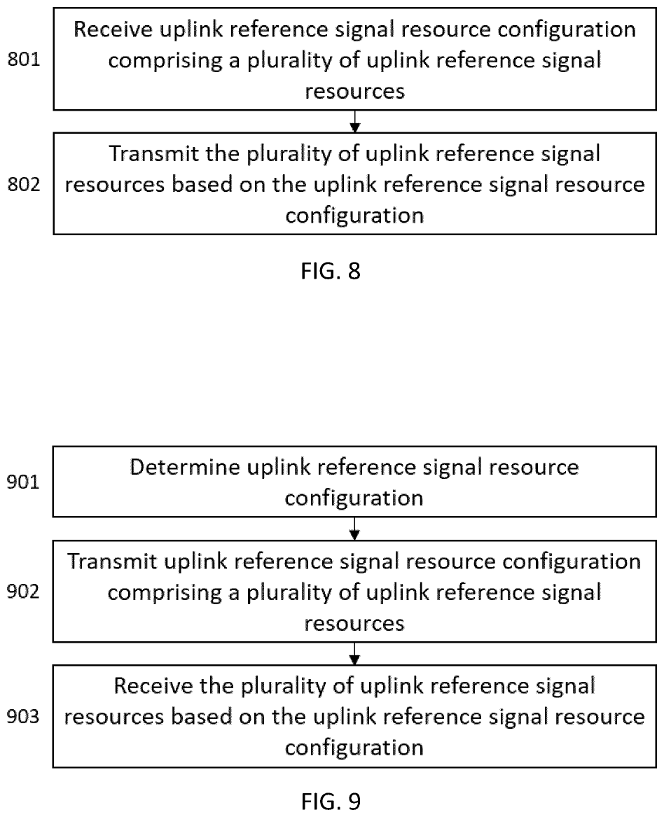

FIG. 9 illustrates a flow chart according to an example embodiment of a method performed by an apparatus such as, or comprising, or comprised in, a network element of a radio access network. The network element may correspond to the access node 104 of FIG. 1.

Referring to FIG. 9, in block 901, an uplink reference signal resource configuration is determined based on at least one of: a maximum number of transmit antenna ports supported by a user device for simultaneous transmissions from the user device to the apparatus, and/or an antenna switching capability of the user device. For example, the uplink reference signal may comprise one of: a sounding reference signal, a demodulation reference signal, or a phase-tracking reference signal.

In block 902, the uplink reference signal resource configuration comprising a plurality of uplink reference signal resources is transmitted to the user device.

In block 903, the plurality of uplink reference signal resources are received from the user device based on the uplink reference signal resource configuration.

The steps and/or blocks described above by means of FIGS. 7-9 are in no absolute chronological order, and some of them may be performed simultaneously or in an order differing from the described one. Other steps and/or blocks may also be executed between them or within them, and other information may be transmitted and/or received. Some of the steps and/or blocks or a part of the steps and/or blocks may also be left out.

Some example embodiments may also be used to enhance legacy UL SRS configurations based on the UE capability signaling described above by reducing the number of guard periods in the legacy UL SRS configurations. In one example, if a UE supports ‘enhanced-SRS-Tx-port-switching’ capability and legacy SRS Tx port switching pattern(s) of ‘txry’ (e.g., t2r2), where x>1 and x≤y, and if up to x SRS resources within an SRS resource set are configured to the UE, no guard period due to the SRS Tx port switching may be expected until up to “x” SRS resources is sounded. For example, in the example embodiment of FIG. 8, at least a subset of the plurality of uplink reference signal resources may be transmitted without a guard period between the at least subset of the plurality of uplink reference signal resources, wherein a number of resources in the at least subset of the plurality of uplink reference signal resources is less than or equal to a number of antenna ports associated with the antenna switching capability of the apparatus.

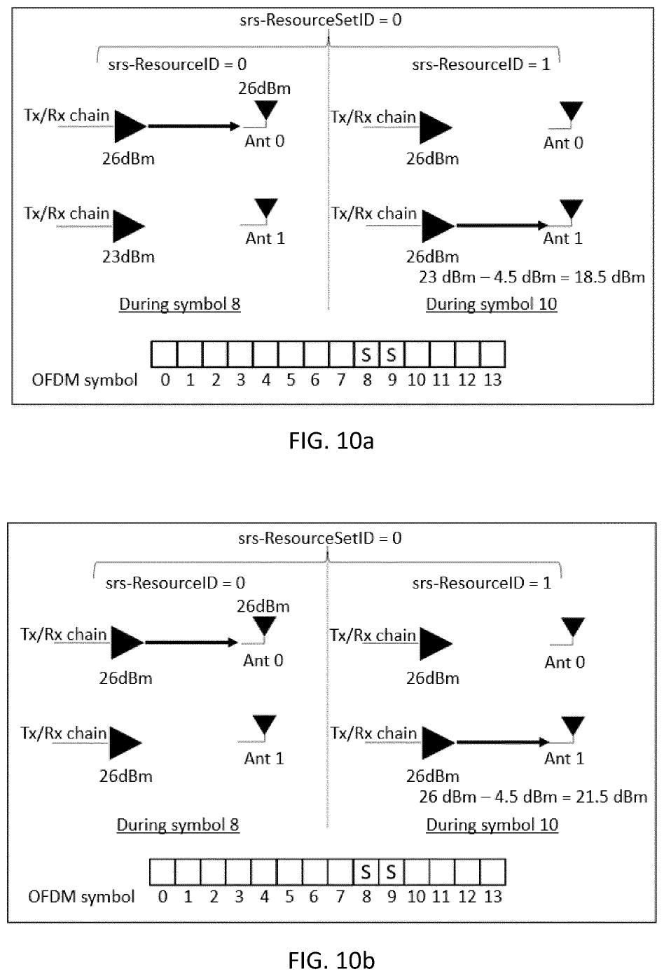

As a more specific example, if a UE supporting a legacy pattern of ‘t2r2’ indicates ‘enhanced-SRS-Tx-port-switching’ capability and two SRS resources within an SRS resource set are configured with the UE, the UE may be able to perform SRS transmit antenna port switching without need for a guard period between the SRS resources within the set. This is illustrated in FIGS. 10a and 10b, wherein the “S” in OFDM symbols #8 and #9 denotes the two SRS resources transmitted without a guard period between them.

FIG. 10a illustrates ‘t1r2’ with ‘enhanced-SRS-Tx-port-switching’ with a 26 dBm+23 dBm power amplifier configuration.

FIG. 10b illustrates ‘t1r2’ with ‘enhanced-SRS-Tx-port-switching’ with a 26 dBm+26 dBm power amplifier configuration.

In another example, if a UE is capable of both ‘enhanced-SRS-Tx-port-switching’ and legacy SRS-Tx-port-switching, the UE may assume there is no guard period between the first N SRS resources, and that there is at least one guard period between the last K-N SRS resources. The N SRS resources are within an SRS resource set(s) configured with ‘enhanced-SRS-Tx-port-switching’, and the K-N SRS resources are within the other SRS resource set(s) configured with legacy SRS-Tx-port-switching. K denotes the total SRS resources configured to the UE. It should be noted that there may be no restriction on the order of usage of ‘enhanced-SRS-Tx-port-switching’ and legacy SRS-Tx-port-switching within multiple resource sets, as well as no restriction on the number of SRS resource sets.

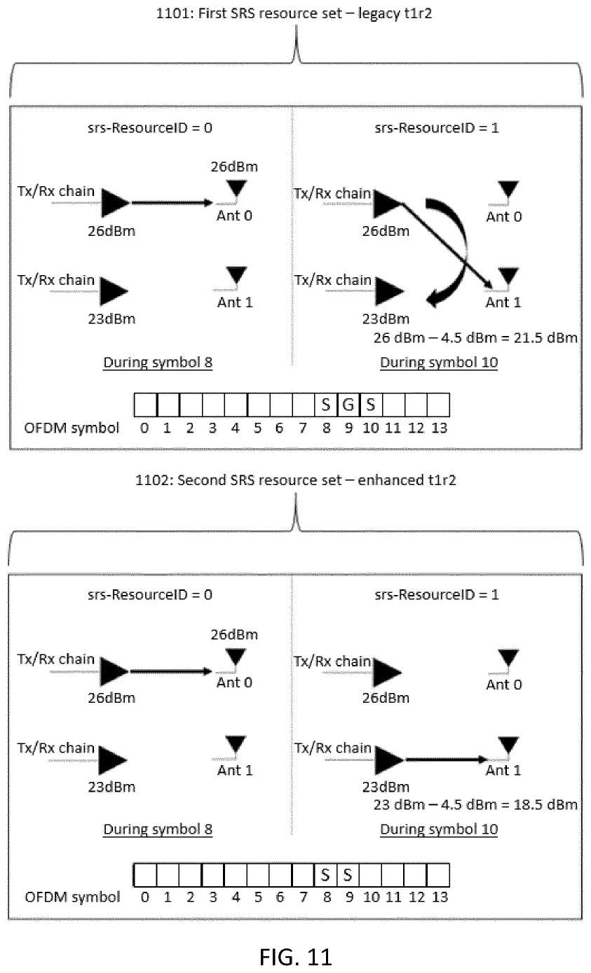

As a more specific example, assume that a UE supports t2r2 (two transmit antenna ports and two receive antenna ports) as well as ‘enhanced-SRS-Tx-port-switching’. In this example, the UE is configured with two SRS resource sets, where two SRS resources, i.e., N=2 and K=4, are configured with a given SRS resource set. The first SRS resource set is configured tied with legacy t1r2, while the second SRS resource set is configured tied with enhanced t1r2 as illustrated in FIG. 11.

FIG. 11 illustrates an example of combined usage of legacy and enhanced t1r2 across SRS resource sets. Block 1101 illustrates a first SRS resource set, which may be a legacy t1r2 resource set. Block 1102 illustrates a second SRS resource set, which may be an enhanced t1r2 resource set. In FIG. 11, “S” denotes an SRS resource, and “G” denotes a guard period.

In one example, if a UE is capable of both ‘enhanced-SRS-Tx-port-switching’ and legacy SRS-Tx-port-switching for a band or a band per band combination, it is considered that the UE supports enhanced-SRS-Tx-port-switching for the fallback SRS-Tx-port-switching of the legacy one in an inherited way. For instance, if the UE supports legacy t2r4 or t4r4, the UE is capable of ‘enhanced-SRS-Tx-port-switching’ for t1r2 or both t1r2 and t1r4, respectively.

In another example, a UE can indicate enhanced SRS-Tx-port-switching patterns explicitly as shown in Table 2 below. Table 2 presents explicit signaling of enhanced-SRS-Tx-port-switching.

TABLE 2

| NR Rel-15 supported | | |
|---|---|---|
| maximum legacy SRS Tx | | |
| port switching pattern | | |
| by a UE for a band | Enhanced-t1r4 | Enhanced-t1r2 |
| t4r4 | Optional | Optional |
| t2r4 | N/A | Optional |
| t2r2 | N/A | Optional |

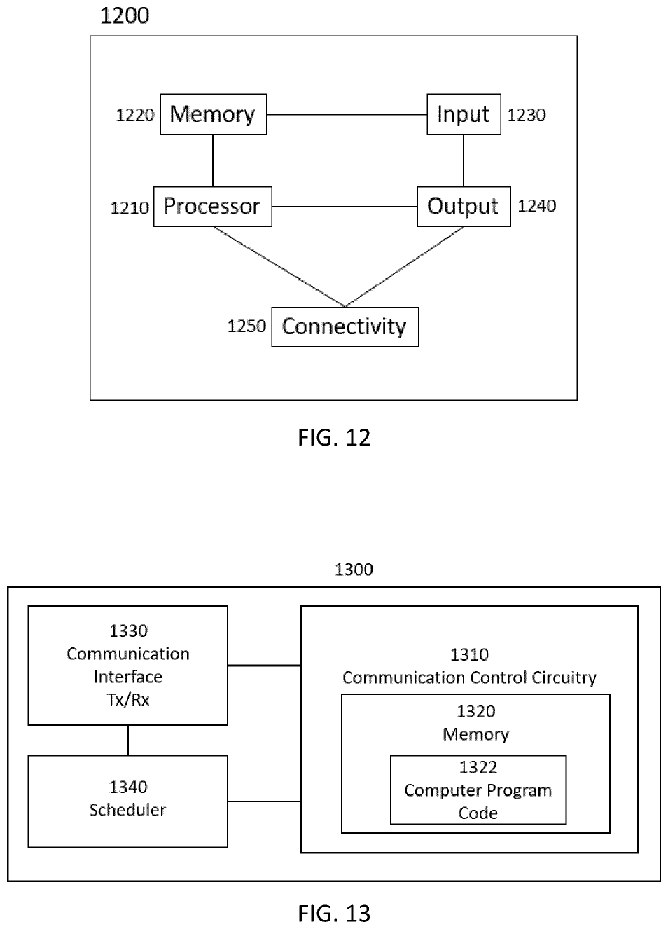

FIG. 12 illustrates an example embodiment of an apparatus 1200, which may be an apparatus such as, or comprising, or comprised in, a user device. The user device may correspond to one of the user devices 100, 102 of FIG. 1. The user device may also be called a subscriber unit, mobile station, remote terminal, access terminal, user terminal, terminal device, or user equipment (UE).

The apparatus 1200 comprises at least one processor 1210. The at least one processor 1210 interprets computer program instructions and processes data. The at least one processor 1210 may comprise one or more programmable processors. The at least one processor 1210 may comprise programmable hardware with embedded firmware and may, alternatively or additionally, comprise one or more application-specific integrated circuits (ASICs).

The at least one processor 1210 is coupled to at least one memory 1220. The at least one processor is configured to read and write data to and from the at least one memory 1220. The at least one memory 1220 may comprise one or more memory units. The memory units may be volatile or non-volatile. It is to be noted that in some example embodiments there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The at least one memory 1220 stores computer readable instructions that are executed by the at least one processor 1210 to perform one or more of the example embodiments described above. For example, non-volatile memory stores the computer readable instructions, and the at least one processor 1210 executes the instructions using volatile memory for temporary storage of data and/or instructions.

The computer readable instructions may have been pre-stored to the at least one memory 1220 or, alternatively or additionally, they may be received, by the apparatus, via an electromagnetic carrier signal and/or may be copied from a physical entity such as a computer program product. Execution of the computer readable instructions causes the apparatus 1200 to perform one or more of the functionalities described above.

In the context of this document, a “memory” or “computer-readable media” or “computer-readable medium” may be any non-transitory media or medium or means that can contain, store, communicate, propagate or transport the instructions for use by or in connection with an instruction execution system, apparatus, or device, such as a computer.

The apparatus 1200 may further comprise, or be connected to, an input unit 1230. The input unit 1230 may comprise one or more interfaces for receiving input. The one or more interfaces may comprise for example one or more temperature, motion and/or orientation sensors, one or more cameras, one or more accelerometers, one or more microphones, one or more buttons and/or one or more touch detection units. Further, the input unit 1230 may comprise an interface to which external devices may connect to.

The apparatus 1200 may also comprise an output unit 1240. The output unit may comprise or be connected to one or more displays capable of rendering visual content, such as a light emitting diode (LED) display, a liquid crystal display (LCD) and/or a liquid crystal on silicon (LCoS) display. The output unit 1240 may further comprise one or more audio outputs. The one or more audio outputs may be for example loudspeakers.

The apparatus 1200 further comprises a connectivity unit 1250. The connectivity unit 1250 enables wireless connectivity to one or more external devices. The connectivity unit 1250 comprises at least one transmitter and at least one receiver that may be integrated to the apparatus 1200 or that the apparatus 1200 may be connected to. The at least one transmitter comprises at least one transmit antenna, and the at least one receiver comprises at least one receiving antenna. The connectivity unit 1250 may comprise an integrated circuit or a set of integrated circuits that provide the wireless communication capability for the apparatus 1200. Alternatively, the wireless connectivity may be a hardwired application-specific integrated circuit (ASIC). The connectivity unit 1250 may comprise one or more components, such as: power amplifier, digital front end (DFE), analog-to-digital converter (ADC), digital-to-analog converter (DAC), frequency converter, (de)modulator, and/or encoder/decoder circuitries, controlled by the corresponding controlling units.

It is to be noted that the apparatus 1200 may further comprise various components not illustrated in FIG. 12. The various components may be hardware components and/or software components.

The apparatus 1300 of FIG. 13 illustrates an example embodiment of an apparatus such as, or comprising, or comprised in, a network element of a radio access network. The network element may correspond to the access node 104 of FIG. 1. The network element may also be referred to, for example, as a network node, a radio access network (RAN) node, a NodeB, an eNB, a gNB, a base transceiver station (BTS), a base station, an NR base station, a 5G base station, an access node, an access point (AP), a relay node, a repeater, an integrated access and backhaul (IAB) node, an IAB donor node, a distributed unit (DU), a central unit (CU), a baseband unit (BBU), a radio unit (RU), a radio head, a remote radio head (RRH), or a transmission and reception point (TRP).

The apparatus 1300 may comprise, for example, a circuitry or a chipset applicable for realizing one or more of the example embodiments described above. The apparatus 1300 may be an electronic device comprising one or more electronic circuitries. The apparatus 1300 may comprise a communication control circuitry 1310 such as at least one processor, and at least one memory 1320 storing instructions which, when executed by the at least one processor, cause the apparatus 1300 to carry out one or more of the example embodiments described above. Such instructions may, for example, include a computer program code (software) 1322 wherein the at least one memory and the computer program code (software) 1322 are configured, with the at least one processor, to cause the apparatus 1300 to carry out some of the example embodiments described above. Herein computer program code may in turn refer to instructions that cause the apparatus 1300 to perform one or more of the example embodiments described above. That is, the at least one processor and the at least one memory 1320 storing the instructions may cause said performance of the apparatus.

The processor is coupled to the memory 1320. The processor is configured to read and write data to and from the memory 1320. The memory 1320 may comprise one or more memory units. The memory units may be volatile or non-volatile. It is to be noted that in some example embodiments there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The memory 1320 stores computer readable instructions that are executed by the processor. For example, non-volatile memory stores the computer readable instructions and the processor executes the instructions using volatile memory for temporary storage of data and/or instructions.

The computer readable instructions may have been pre-stored to the memory 1320 or, alternatively or additionally, they may be received, by the apparatus, via an electromagnetic carrier signal and/or may be copied from a physical entity such as a computer program product. Execution of the computer readable instructions causes the apparatus 1300 to perform one or more of the functionalities described above.

The memory 1320 may be implemented using any suitable data storage technology, such as semiconductor-based memory devices, flash memory, magnetic memory devices and systems, optical memory devices and systems, fixed memory and/or removable memory. The memory may comprise a configuration database for storing configuration data. For example, the configuration database may store a current neighbour cell list, and, in some example embodiments, structures of the frames used in the detected neighbour cells.

The apparatus 1300 may further comprise a communication interface 1330 comprising hardware and/or software for realizing communication connectivity according to one or more communication protocols. The communication interface 1330 comprises at least one transmitter (Tx) and at least one receiver (Rx) that may be integrated to the apparatus 1300 or that the apparatus 1300 may be connected to. The communication interface 1330 may comprise one or more components, such as: power amplifier, digital front end (DFE), analog-to-digital converter (ADC), digital-to-analog converter (DAC), frequency converter, (de)modulator, and/or encoder/decoder circuitries, controlled by the corresponding controlling units.

The communication interface 1330 provides the apparatus with radio communication capabilities to communicate in the cellular communication system. The communication interface may, for example, provide a radio interface to one or more user devices. The apparatus 1300 may further comprise another interface towards a core network such as the network coordinator apparatus and/or to the access nodes of the cellular communication system.

The apparatus 1300 may further comprise a scheduler 1340 that is configured to allocate radio resources. The scheduler 1340 may be configured along with the communication control circuitry 1310 or it may be separately configured.

It is to be noted that the apparatus 1300 may further comprise various components not illustrated in FIG. 13. The various components may be hardware components and/or software components.

As used in this application, the term “circuitry” may refer to one or more or all of the following: a) hardware-only circuit implementations (such as implementations in only analog and/or digital circuitry); and b) combinations of hardware circuits and software, such as (as applicable): i) a combination of analog and/or digital hardware circuit(s) with software/firmware and ii) any portions of hardware processor(s) with software (including digital signal processor(s), software, and memory(ies) that work together to cause an apparatus, such as a mobile phone, to perform various functions); and c) hardware circuit(s) and/or processor(s), such as a microprocessor(s) or a portion of a microprocessor(s), that requires software (for example firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of example embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, micro-controllers, microprocessors, other electronic units designed to perform the functions described herein, or a combination thereof. For firmware or software, the implementation can be carried out through modules of at least one chipset (for example procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The embodiments are not limited to the example embodiments described above, but may vary within the scope of the claims. Therefore, all words and expressions should be interpreted broadly, and they are intended to illustrate, not to restrict, the example embodiments.

### LIST OF ABBREVIATIONS

4G: fourth generation
5G: new radio/fifth generation
6G: sixth generation
ADC: analog-to-digital converter
AP: access point
AP: antenna port
ASIC: application-specific integrated circuit
BBU: baseband unit
BPSK: binary phase shift keying
CE: control element
CN: core network
CPE: customer-premises equipment
CPS: cyber-physical system
CSI: channel state information
CSI-RS: channel state information reference signal
CSSP: customer-specific standard product
CU: central unit
CU-CP: central unit control plane
CU-UP: central unit user plane
DAC: digital-to-analog converter
DFE: digital front end
DL: downlink
DMRS: demodulation reference signal
DRAM: dynamic random-access memory
DSP: digital signal processor
DSPD: digital signal processing device
DU: distributed unit
EEPROM: electronically erasable programmable read-only memory
eNB: evolved NodeB/4G base station
FeMIMO: further enhanced MIMO
FPGA: field programmable gate array
FR1: frequency range one
FR2: frequency range two
FWA: fixed wireless access
GEO: geostationary earth orbit
gNB: next generation NodeB/5G base station
GP: guard period
GPU: graphics processing unit
HNB-GW: home node B gateway
IAB: integrated access and backhaul
IMS: internet protocol multimedia subsystem
IoT: internet of things
L1: Layer1
L2: Layer 2
L3: Layer 3
LCD: liquid crystal display
LCoS: liquid crystal on silicon
LED: light emitting diode
LEO: low earth orbit
LTE: longterm evolution
LTE-A: long term evolution advanced
M2M: machine-to-machine
MAC: medium access control
MANET: mobile ad-hod network
MEC: multi-access edge computing
MIMO: multiple input and multiple output
MME: mobility management entity
mMTC: massive machine-type communications
MT: mobile termination
Multi-TRP: multiple transmission and reception point
NFV: network function virtualization
NGC: next generation core
NR: new radio
NZP: non-zero power
PCS: personal communications services
PDA: personal digital assistant
PDCP: packet data convergence protocol
P-GW: packet data network gateway
PHY: physical
PLD: programmable logic device
PROM: programmable read-only memory
PTRS: phase-tracking reference signal
QCL: quasi co-location
RAM: random-access memory
RAN: radio access network
RAP: radio access point
RAT: radio access technology
Rel: Release
RF: radio frequency
RI: radio interface
RLC: radio link control
ROM: read-only memory
RRC: radio resource control
RRH: remote radio head
RS: reference signal
RU: radio unit
RX: receiver
SCS: subcarrier spacing
SDAP: service data adaptation protocol
SDN: software defined networking
SDRAM: synchronous dynamic random-access memory
S-GW: serving gateway
SIM: subscriber identification module
SL: sidelink
SoC: system-on-a-chip
SRS: sounding reference signal
SSB: synchronization signal block
TRP: transmission and reception point
TRX: transceiver
TX: transmitter
UE: user equipment
UL: uplink
UMTS: universal mobile telecommunications system
UTRAN: UMTS radio access network
UWB: ultra-wideband
vCU: virtualized central unit
vDU: virtualized distributed unit
WCDMA: wideband code division multiple access
WiMAX: worldwide interoperability for microwave access
WLAN: wireless local area network

The invention claimed is:

1-34. (canceled)

35. An apparatus comprising at least one processor, and at least one memory comprising computer program code that, when executed by at least one processor, causes the apparatus to:
receive, from a network element of a radio access network, an uplink reference signal resource configuration comprising a plurality of uplink reference signal resources, wherein the uplink reference signal resource configuration is based on at least one of:
a maximum number of transmit antenna ports supported for simultaneous transmissions from the apparatus to the network, or an antenna switching capability; and
transmit, to the network element, the plurality of uplink reference signal resources based on the uplink reference signal resource configuration.

36. The apparatus according to claim 35, wherein transmitting the plurality of uplink reference signal resources comprises transmitting an uplink reference signal in each of the plurality of uplink reference signal resources.

37. The apparatus according to claim 36, wherein the plurality of uplink reference signal resources comprises at least a first resource and a second resource, wherein at least one of the first and second resources is associated with a different number of antenna ports.

38. The apparatus according to claim 37, wherein the first resource and the second resource are transmitted with at least one guard period between the first resource and the second resource.

39. The apparatus according to claim 36, wherein a number of antenna ports associated with the first resource, or the second resource is equal to the maximum number of transmit antenna ports supported for the simultaneous transmissions.

40. The apparatus according to claim 36, wherein the plurality of uplink reference signal resources comprises at least two resources that are transmitted in consecutive symbols without a guard period between the at least two resources, wherein a sum of antenna ports associated with the at least two resources are less than or equal to the maximum number of transmit antenna ports supported for the simultaneous transmissions.

41. The apparatus according to claim 40, wherein a number of resources comprised in the plurality of uplink reference signal resources is equal to a number of receive antenna ports divided by a number of antenna ports associated per resource of the plurality of uplink reference signal resources.

42. The apparatus according to claim 41, wherein a further resource of the plurality of uplink reference signal resources is transmitted with at least one guard period between the further resource and the at least two resources, wherein a sum of antenna ports associated with the further resource and the at least two resources exceed the maximum number of transmit antenna ports supported for the simultaneous transmissions.

43. The apparatus according to claim 36, wherein at least a subset of the plurality of uplink reference signal resources are transmitted without a guard period between the at least subset of the plurality of uplink reference signal resources, wherein a number of resources in the at least subset of the plurality of uplink reference signal resources is less than or equal to a number of antenna ports associated with the antenna switching capability.

44. The apparatus according to claim 36, wherein the computer program code, when executed by at least one processor, further causes the apparatus to:
transmit, to the network element, one or more indications indicating at least one of: the maximum number of transmit antenna ports supported for the simultaneous transmissions, the antenna switching capability, wherein the antenna switching capability indicates a capability to transmit an uplink reference signal on two or more antenna ports of a plurality of receive antenna ports of the apparatus.

45. An apparatus comprising at least one processor, and at least one memory including computer program code that, when executed by at least one processor, causes the apparatus to:
determine an uplink reference signal resource configuration based on at least one of: a maximum number of transmit antenna ports supported by a user device for simultaneous transmissions from the user device to the apparatus, or an antenna switching capability of the user device;
transmit, to the user device, the uplink reference signal resource configuration comprising a plurality of uplink reference signal resources; and
receive, from the user device, the plurality of uplink reference signal resources based on the uplink reference signal resource configuration.

46. The apparatus according to claim 45, wherein receiving the plurality of uplink reference signal resources comprises receiving an uplink reference signal in each of the plurality of uplink reference signal resources.

47. The apparatus according to claim 46, wherein the plurality of uplink reference signal resources comprises at least a first resource and a second resource, wherein at least one of the first and second resources is associated with a different number of antenna ports.

48. The apparatus according to claim 46, wherein the first resource and the second resource are received with at least one guard period between the first resource and the second resource.

49. The apparatus according to claim 46, wherein a number of antenna ports associated with the first resource, or the second resource is equal to the maximum number of transmit antenna ports supported by the user device for the simultaneous transmissions.

50. The apparatus according to claim 46, wherein the plurality of uplink reference signal resources comprises at least two resources that are received in consecutive symbols without a guard period between the at least two resources, wherein a sum of antenna ports associated with the at least two resources is less than or equal to the maximum number of transmit antenna ports supported by the user device for the simultaneous transmissions.

51. The apparatus according to claim 50, wherein a number of resources comprised in the plurality of uplink reference signal resources is equal to a number of receive antenna ports of the user device divided by a number of antenna ports associated per resource of the plurality of uplink reference signal resources.

52. The apparatus according to claim 50, wherein a further resource of the plurality of uplink reference signal resources is received with at least one guard period between the further resource and the at least two resources, wherein a sum of antenna ports associated with the further resource and the at least two resources exceeds the maximum number of transmit antenna ports supported by the user device for the simultaneous transmissions.

53. The apparatus according to claim 46, wherein at least a subset of the plurality of uplink reference signal resources are received without a guard period between the at least subset of the plurality of uplink reference signal resources, wherein a number of resources in the at least subset of the plurality of uplink reference signal resources is less than or equal to a number of antenna ports associated with the antenna switching capability of the user device.

54. The apparatus according to claim 46, wherein the computer program code, when executed by at least one processor, further causes the apparatus to:
receive, from the user device, one or more indications indicating at least one of: the maximum number of transmit antenna ports supported by the user device for the simultaneous transmissions, or the antenna switching capability of the user device, wherein the antenna switching capability of the user device indicates a capability to transmit an uplink reference signal on two or more antenna ports of a plurality of receive antenna ports of the user device.
